(19) United States
(12) Patent Application Publication
(10) Pub. No.: US 2008/0193633 A1
(43) Pub. Date: Aug. 14, 2008

(54) METHOD OF STABILIZATION AND ANCHORING FOR LOW DENSITY OBJECTS

(76) Inventors: Christian Rath, Crown Point, IN (US); Andrew P. Verrall, Crown Point, IN (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/673,284

(22) Filed: Feb. 9, 2007

(51) Int. Cl. A01N 1/00

(52) U.S. Cl. 427/4

(57) ABSTRACT

A method of stabilization and anchoring for low density objects such as leaves, including applying to the surface of a collection of leaves a solution including a water-soluble polymer selected from the group consisting of polyvinyl alcohol, derivatives thereof, and combinations thereof, at a rate of 0.5 g/m² to 20 g/m², on a dry basis, and suitable solutions for the method optionally including crosslinking agents, surfactants, plasticizers, nanoparticulates, and tackifying agents, are disclosed.

### BACKGROUND

1. Field of the Disclosure

The disclosure relates generally to the stabilization of a mass of low density objects against disruption. More particularly, the disclosure relates to a method of suppressing the wind-blowing of low density objects such as leaves by applying a solution of a water-soluble polymer to an aggregate collection of loose leaves.

2. Brief Description of Related Technology

It is desirable to collect masses of fallen leaves either without or prior to placing them into a container such as a garbage bag or can. For instance, some local sanitation departments and/or waste collection service providers require that fallen leaves be collected and left in curbside piles to facilitate later collection (e.g., by a large, vehicle-mounted vacuum) and disposal (e.g., by incineration or by inclusion into agricultural products).

In these cases, leaves that are raked or otherwise aggregated into piles may be subsequently dispersed by wind prior to collection. It would be inconvenient to temporarily store the aggregated leaves in a wind-resistant container and then remove the leaves from the container just prior to collection. Similarly, it is inefficient to re-rake leaves disrupted by wind in between initial raking and ultimate collection.

A method of addressing this problem is simply to rake fallen leaves just prior to collection. However, this can place undesirable time restrictions on the property owner, who may be unable to coordinate raking times with collection times.

Similarly, property owners have resorted to the use of a net or tarp (that is secured to the ground) to cover a collection of leaves. While removal of the net or tarp is simpler than removing the leaves from a sealed garbage bag or can, it still requires a manual step by the property owner just prior to leaf collection.

### SUMMARY

One aspect of the disclosure provides a method of stabilizing an aggregated mass of low density objects comprising the step of applying to the outer surface of the aggregated mass a solution including a water-soluble polymer. In one embodiment, the low density objects are leaves. The water-soluble polymer can be polyvinyl alcohol, or a derivative thereof, and may be applied at a rate of 0.5 g/m² to 20 g/m², on a dry basis.

Further aspects and advantages will be apparent to those of ordinary skill in the art from a review of the following detailed description. While the method is susceptible of embodiments in various forms, the description hereafter includes specific embodiments with the understanding that the disclosure is illustrative, and is not intended to limit the invention to the specific embodiments described herein.

### DETAILED DESCRIPTION

The method and compositions described herein are useful for the stabilization and anchoring of low density objects, protecting them from disruption, such as by wind force. The method includes applying a solution of a water-soluble polymer to the outer surface of an aggregated mass of low density objects.

In the specific embodiments described below, the low density objects are leaves, typically those that have fallen from a tree and must be collected for disposal. However, the method and compositions described herein apply equally to the class of low density objects, which, as used herein, connotes objects having a mass-to-surface area ratio low enough to make them susceptible to wind disruption. Thus, those objects that have a low material density or that displace a large volume compared to their mass are low density objects. Examples of such objects include straw and foam. Similarly, those objects that have a high surface area-to-volume ratio (and thus a low mass-to-surface area ratio) are also susceptible to wind disruption. Examples of such objects include leaves, paper products, and other sheet-like objects.

The general method includes applying to the surface of a collection of leaves a single-phase solution including a water-soluble polymer such as polyvinyl alcohol (PVOH), derivatives thereof, and combinations of the foregoing. It is also believed that a water-insoluble polymer in the form of a multiphase solution may be useful in the method described herein.

In one embodiment the polymer will consist essentially of, or consist only of, PVOH and/or a copolymer thereof. Preferably, the polymer will consist essentially of, or consist only of, PVOH. If polyvinyl alcohol or a copolymer thereof is used, then the PVOH can be partially or fully hydrolyzed. Polyvinyl alcohol (PVOH) is a synthetic resin generally prepared by the alcoholysis, usually termed hydrolysis or saponification, of polyvinyl acetate.

Fully hydrolyzed PVOH, where virtually all the acetate groups have been converted to alcohol groups (e.g., 98% or greater degree of hydrolysis), is a strongly hydrogen-bonded, highly crystalline polymer which dissolves only in hot water—e.g., rapid dissolution at temperatures of about 60° C. and greater. The degree of hydrolysis is preferably not larger than 99.5% of all acetate groups.

If a sufficient number of acetate groups are allowed to remain after the hydrolysis of polyvinyl acetate, the PVOH polymer is known as partially hydrolyzed, meaning that it is more weakly hydrogen-bonded and less crystalline and is soluble in cold water—e.g., rapid dissolution at temperatures of about 10° C. and greater. Cold-water soluble polymers are preferred.

Both fully and partially hydrolyzed PVOH types are commonly referred to as PVOH homopolymers although the partially hydrolyzed type is technically a vinyl alcohol-vinyl acetate copolymer.

An intermediate cold/hot water soluble polymer can include, for example, blends of partially-hydrolyzed PVOH (e.g., with degrees of hydrolysis of about 94% to about 98%), and is readily soluble only in warm water—e.g., rapid dissolution at temperatures of about 40° C. and greater.

The term PVOH copolymer is generally used to describe polymers that are derived by the hydrolysis of a copolymer of a vinyl ester, typically vinyl acetate, and another monomer. PVOH copolymers can be tailored to desired film characteristics by varying the kind and quantity of copolymerized monomers. Examples of copolymerizations are those of vinyl acetate with a carboxylic acid or with an ester of a carboxylic acid. Again, if the hydrolysis of acetate groups in these copolymers is only partial, then the resulting polymer could also be described as a PVOH terpolymer—having vinyl acetate, vinyl alcohol, and carboxylic acid groups—although it is commonly referred to as a copolymer.

The water-soluble polymer is characterized according to the resulting viscosity of a 4% aqueous solution of the polymer. Preferably, the 4% solution viscosity is in a range of about 5 cP to about 40 cP at 20° C., and is more preferably about 10 cP to about 30 cP at 20° C.

The method and solution are contemplated to include embodiments including any combination of one or more of the additional optional elements, features, and steps further described below, unless stated otherwise.

The water-soluble polymer may include a crosslinking agent. The crosslinking agent can improve the resistance of the polymer matrix applied to a collection of leaves with respect to deteriorating environmental effects such as rain and air humidity.

For PVOH as the water-soluble polymer, crosslinking agents can be selected from any chemical agent that can form chemical bonds with the hydroxyl groups of PVOH. Such crosslinking agents include, for example, monoaldehydes (e.g., formaldehyde and hydroxyacetaldehyde), dialdehydes (e.g., glyoxal, glutaraldehyde and succinic dialdehyde), aldehyde-containing resins (e.g., trimethylol melamine), dicarboxylic acids (e.g., maleic, oxalic, malonic and succinic acids), citric acid, glycidyl and other difunctional methacrylates, N-lactam carboxylates, dithiols (e.g., m-benzodithiol), boric acid and borates, ammonium zirconium carbonate, inorganic polyions (e.g., molybdate and tungstate), cupric salts and other Group 1B salts, and polyamide-epichlorohydrin resin (polyazetidine prepolymer).

Rather than those crosslinking agents which undergo direct condensation reactions with hydroxyl groups (such as esterification and acetalization reactions with carboxylic acids and aldehydes, respectively), preferred crosslinking agents—for reasons of solution stability and rheology—are those that have one or more of the following functionalities: those that form complexes via labile polar covalent interactions, those that crosslink via ionic interactions, those that crosslink via hydrogen bonding interactions, and combinations of such crosslinking agents. Examples of such preferred crosslinking agents are borates, boric acid, ammonium zirconium carbonate, inorganic polyions such as molybdate and tungstate, cupric salts and other Group 1B salts, and polyamide-epichlorohydrin resin, and combinations thereof. Water-soluble polyamide-epichlorohydrin is available under the trade name POLYCUP 172 by Hercules, Inc. of Wilmington, Del. A particularly preferred crosslinking agent for PVOH is boric acid.

The crosslinking agent, when used, is preferably present in an amount of less than 8 wt. %, and more preferably present in an amount of about 0.5 wt. % to about 5 wt. %, based on the weight of the water-soluble polymer, such as PVOH.

The solution can optionally include a plasticizer. The plasticizer helps form flexible interstitial bonds between the fallen leaves and, thus, makes the bonded mass less subject to fracture. Glycerin is a preferred plasticizer. With PVOH, for example, in preferred embodiments glycerin is used in an amount from about 5 percent by weight (wt. %) to about 40 wt. % of the solution, on a dry basis. Other plasticizers suitable for use with PVOH are known in the art and are contemplated for use in the solution described herein.

The solution can optionally include a surfactant. The surfactant can aid in wetting out of the solution on the leaf surfaces. Penetration below the outer surface of the aggregated pile of leaves is also possible. Suitable surfactants can include the nonionic, cationic, anionic zwitterionic classes. Preferably, the surfactants will be of the nonionic, cationic or zwitterionic classes or combinations of these. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). Preferred surfactants are alcohol ethoxylates, quaternary ammonium salts and amine oxides. Preferably, the surfactant has a hydrophile-lipophile balance (HLB) of 10 or greater, more preferably greater than 10.

The solution can optionally include nanoclays or other nanoscale particulate materials. The nanoparticulates can enhance the barrier properties (e.g., water resistance) and strength of the film formed from the polymer solution. Suitable nanoscale particulate materials include natural layered silicate materials (clays), including the smectite family of nanoclays, synthetic layered silicates (e.g., LAPONITE clay, available from Laporte Industries Plc, UK), nanocrystalline main group metal oxides, nanocrystalline rare earth oxides, nanocrystalline transition metal oxides, nanocrystalline mixed oxides of the foregoing; nanocrystalline main group metal phosphates and phosphonates, nanocrystalline transition metal phosphates and phosphonates, and nanocrystalline alkaline earth metal phosphates and phosphonates; nanocrystalline chalcogenide compounds; nanocrystalline fullerene aggregates, and combinations of any of the foregoing.

Preferred hydrophilic nanoclays are selected from the smectite family of nanoclays (e.g., aliettite, beidellite, hectorite, montmorillonite, nontronite, saponite, sauconite, stevensite, swinefordite, volkonskoite, yakhontovite, and zincsilite). More preferred is a montmorillonite such as sodium montmorillonite. Sodium montmorillonite is available under the trade name CLOISITE NA from Southern Clay Products, Inc., of Gonzales, Tex. The nanoscale particulate material preferably is included in an amount from about 2 wt. % to about 5 wt. % of the solution on a dry basis.

In one type of embodiment, the solution can include a color agent, for example to serve as an indicator for application. Colorants are known which remain colored in aqueous solution and which become clear upon drying. Use of such colorants is contemplated.

For use in leaf stabilization and anchoring, the solution of water-soluble polymer and optional additives preferably has a solids content in a range of about 4 wt. % to about 12 wt. %.

The solution can be created by dissolving a solids mixture including the water-soluble polymer into water, or by diluting a prepared concentrated solution. Preferred forms of the solids mixture of components include spray-dried powders, pelletized solids, and flaked solids. The solids can be provided in a water-soluble bag made from the same or a different water-soluble polymer, which can then easily be dissolved in the field to yield a suitable solution.

The rate of application of the solution is preferably such that it yields a surface density of 0.5 g/m² to 20 g/m², more preferably 2 g/m² to 6 g/m², on a dry basis. The applicable amount of dry solution is the residual solid polymer (e.g., PVOH) remaining after the solution has been applied and the aqueous solvent has evaporated. The applicable surface area of coverage is the surface area of a semi-hemispherical dome that would cover the leaf pile.

In one embodiment, a fixed amount of solution volume per unit area may be applied using a solution having a solids content of about 4 wt. %, 8 wt. %, or 12 wt. % to result in surface densities of about 4 g/m², 8 g/m², or 12 g/m², respectively. This allows the user to select the strength of the residual solid polymer while consuming the solution at a fixed volumetric rate. In an alternative embodiment, the applied amount of solution volume per unit area may be varied such that, for example, a more dilute (and less viscous) solution is used to facilitate pumping or a more concentrated (and more viscous) solution is used to limit runoff from the leaf substrate.

The solution is preferably applied in such a manner as to yield a fine mist comprising substantially discrete droplets of solution, rather than flooding the leaf substrate with solution, which can tend to cause runoff rather than an even coating and penetration of solution into the top layer(s) of leaves. Application of a fine mist can be achieved with a hand-held sprayer, which is known in the art. Alternatively, sprayers with larger liquid reservoirs and/or spray head coverage may be back-mounted, cart-mounted, or even vehicle mounted for increased solution application demands. A preferred application method includes liquid pressure distribution, which pressure may be generated by a manually actuated pump, a canister of compressed gas, or a compressor, for example. In some instances, a sprayer adapted for use in the present method may require an increased nozzle orifice due to an increased water-soluble polymer solution viscosity (as compared to a more typical fluid such as a low viscosity aqueous herbicide or pesticide solution). A suitable sprayer can be selected from the various pressurized sprayers available from Chapin International, Inc., Batavia, N.Y. Preferably, a spray apparatus will be positioned directly above the area being treated (e.g., 8 inches to 14 inches; 20 cm to 36 cm) to avoid driftage and runoff.

A fine droplet size of solution during application is especially preferred with solutions having relatively high concentration of polymer (e.g., 4 wt. % to 12 wt. %), to achieve suitable coating of and penetration into the leaf substrate and avoid runoff.

Optionally, the fallen leaves can be pre-wet with water or an aqueous solution lacking the water-soluble polymer (e.g., including a surfactant), prior to applying the solution having the water-soluble polymer.

The desired applied solids content can be achieved by one or more application steps onto the exposed surface of a collection of leaves. The method is believed to result in improved leaf stabilization and anchoring using a surface blanket of polymer optionally combined with surface penetration mechanisms.

In one application, an aqueous solution of the water-soluble polymer (with any optional additives) is mixed and added to a hand-held sprayer. Alternatively, the solution contents may be mixed together in the sprayer reservoir itself. Then, fallen leaves strewn about the property are amassed by any convenient means (e.g., with a rake or leaf blower) into conveniently sized piles near the point of collection (e.g., the curb). The hand-held sprayer is then pressurized and used to apply an aqueous mist of the solution over the surface of the leaf piles until the desired polymer surface density is achieved. Without intending to be limited by any particular theory, it is believed that after curing, the water-soluble polymer and optional additives, preferably in the amounts described herein, act to form interstitial bonds between neighboring leaves in a pile. When the polymer is not crosslinked, the resultant system is relatively flexible, especially when a plasticizer is used. However, regardless of the actual mechanism, the resulting anchored mass of leaves is sufficiently resilient to resist gusts of wind. At the same time, the stabilized mass of leaves may be easily fragmented at the time of collection by either mechanical means (e.g., a shovel or rake) or high-speed pneumatic means (e.g., a powerful, vehicle-mounted vacuum).

Various embodiments of the method and solution described herein can optionally yield one or more advantages. For example, the method described herein provides a solution which is convenient and easy to apply, which reduces waste, and facilitates leaf collection. Application equipment can be washed out by hot or cold water; no organic thinners are necessary, and equipment is not corroded by the solution. The solution is non-toxic and biodegradable, and skin contact is not hazardous.

### EXAMPLE

The following example is provided for illustration and is not intended to limit the scope of the invention.

Leaves were first collected into a pile. A 4 wt. % solution comprising (1) 65 parts of a fully hydrolyzed PVOH copolymer having anionic functionality and a 4% solution viscosity of 20 cP at 20° C., (2) 28.5 parts of plasticizers including glycerin, and (3) 6.5 parts of surfactants and extenders including starch was applied to the pile using a hand-held, manually actuated sprayer as a fine mist. The total amount applied, once dried, resulted in a frost-like coating having a surface density of about 4.24 g/m². The leaf pile remained outside, undisturbed for a total of 12 days prior to collection by a vehicle-mounted vacuum. Four of the 12 days during the environmental exposure period experienced substantial wind forces.

The foregoing description is given for clearness of understanding only, and no unnecessary limitations should be understood therefrom, as modifications within the scope of the invention may be apparent to those having ordinary skill in the art.

Throughout the specification, where the composition is described as including components or materials, it is contemplated that the compositions can also consist essentially of, or consist of, any combination of the recited components or materials, unless described otherwise.

The practice of a method disclosed herein, and individual steps thereof, can be performed manually and/or with the aid of mechanical and/or electronic equipment. Although processes have been described with reference to particular embodiments, a person of ordinary skill in the art will readily appreciate that other ways of performing the acts associated with the methods may be used. For example, the order of various of the steps may be changed without departing from the scope or spirit of the method, unless described otherwise. In addition, some of the individual steps can be combined, omitted, or further subdivided into additional steps.

1. A method of stabilizing an aggregated mass of low density objects against dispersion by wind force, the method comprising:
applying to an outer surface formed by an aggregated mass of low density objects a solution comprising a water-soluble polymer.

2. The method of claim 1, wherein the applying comprises applying the solution at a rate of 0.5 g/m² to 20 g/m², on a dry basis.

3. The method of claim 2, wherein the applying comprises applying the solution at a rate of 2 g/m² to 6 g/m², on a dry basis.

4. The method of claim 1, wherein the low density objects are leaves.

5. The method of claim 1, wherein the solution comprises a polymer crosslinking agent.

6. The method of claim 1, wherein the water-soluble polymer is selected from the group consisting of polyvinyl alcohol, derivatives thereof, and combinations thereof.

7. The method of claim 1, wherein the solution further comprises a plasticizer.

8. The method of claim 7, wherein the plasticizer is present in an amount in a range from 5 wt. % to 40 wt. % of the composition, on a dry basis.

9. The method of claim 1, wherein the solution further comprises a surfactant.

10. The method of claim 1, wherein the solution further comprises a nanoscale particulate material.

11. The method of claim 1, wherein the water-soluble polymer has a 4% solution viscosity in a range of 1 cP to 40 cP at 20° C.

12. The method of claim 1, wherein the solution comprises 4 wt. % to 12 wt. % solids.

13. The method of claim 1, wherein the applying step comprises spraying the solution.

14. The method of claim 13, wherein the spraying of the solution creates a mist comprising substantially discrete droplets.
